(19) United States
(12) Patent Application Publication
(10) Pub. No.: US 2009/0313920 A1
(43) Pub. Date: Dec. 24, 2009

(54) TYPE OF SHUTTER

(75) Inventor: Serge Jaure, Ganges (FR)

Correspondence Address: YOUNG & THOMPSON, 209 Madison Street, Suite 500, Alexandria, VA, 22314, US

(73) Assignee: Serge Jaure, Ganges (FR)

(21) Appl. No.: 11/912,972

(22) PCT Filed: Apr. 24, 2006
(86) PCT No.: PCT/FR2006/000909

§ 371 Date: May 22, 2008

(30) Foreign Application Priority Data
Apr. 27, 2005 (FR) 0504226

(51) Int. Cl. E06B 9/02

(52) U.S. Cl. 52/203

(57) ABSTRACT

The object of this invention is a new type of shutter for the opening (2) of a building intended to protect it against inclement weather. The shutter is located on the facade in front of the window or the French window or picture window and is composed of a wall (4) that is made of one or more elements made of a transparent material.

This invention relates to a new type of shutter for openings, windows or French windows of a building or a picture window.

Shutters are traditionally arranged on the facade in front of the windows, or French windows, and are designed as a means of protection against inclement weather: cold, wind, rain, solar radiation.

Usually, shutters are opaque or have ornamental apertures, and at the same time perform the function of blocking and concealing the opening.

They must be manipulated in opening for inhabited locations, morning and evening or during the day in the case of heavy weather, for example.

The disadvantage of the known shutters is that the protective function of blocking of the opening cannot be separated from its concealing function: once the shutter is closed, it both keeps out light and blocks the view.

The first object of the invention is to eliminate this disadvantage by suggesting a shutter that when placed in front of the opening always performs the protective function of blocking while allowing in light and the view.

Another object of the invention is to devise a shutter that—placed in a fixed position in front of the opening—plays an insulating part by forming a buffer space, which likewise plays the part of passive solar collector; this optimizes the solar gain and according to a certain modality of construction allows natural ventilation via the opening, and it can be removed when it is not of use, for example between seasons, or else for reasons of cleaning.

For this purpose, the new type of shutter for the opening of a building intended to protect against inclement weather, said shutter being located in front of the window or the French window, is characterized essentially in that it is composed of a wall with one or more elements made of a transparent material.

According to another arrangement of the invention, the shutter is made of a rigid and transparent material.

According to still another arrangement of the invention, the shutter according to the invention is fixed on the frame of the opening so as to be removable and/or movable.

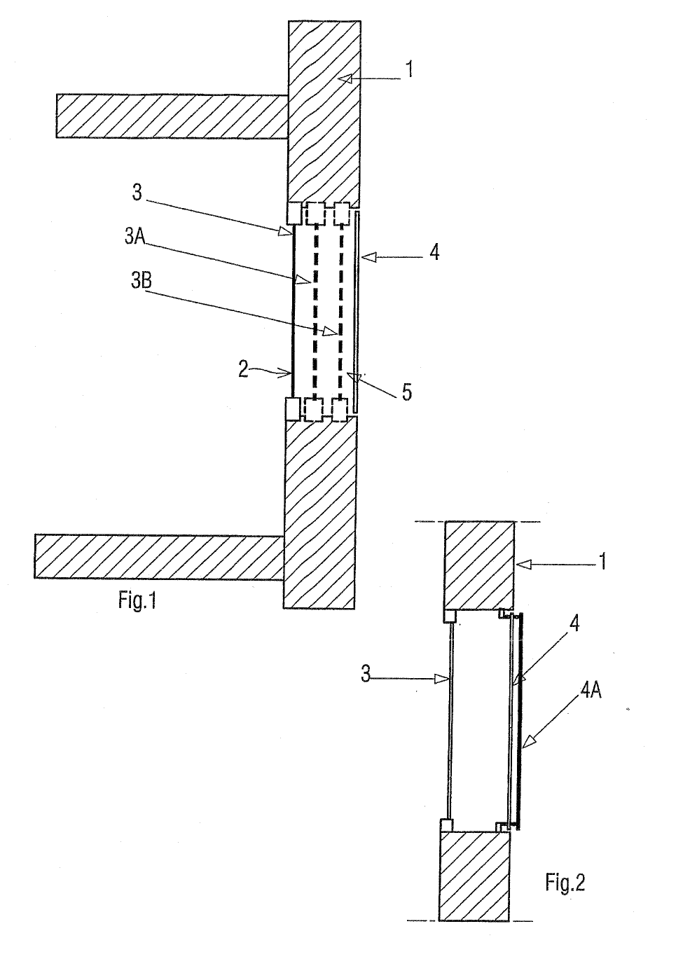

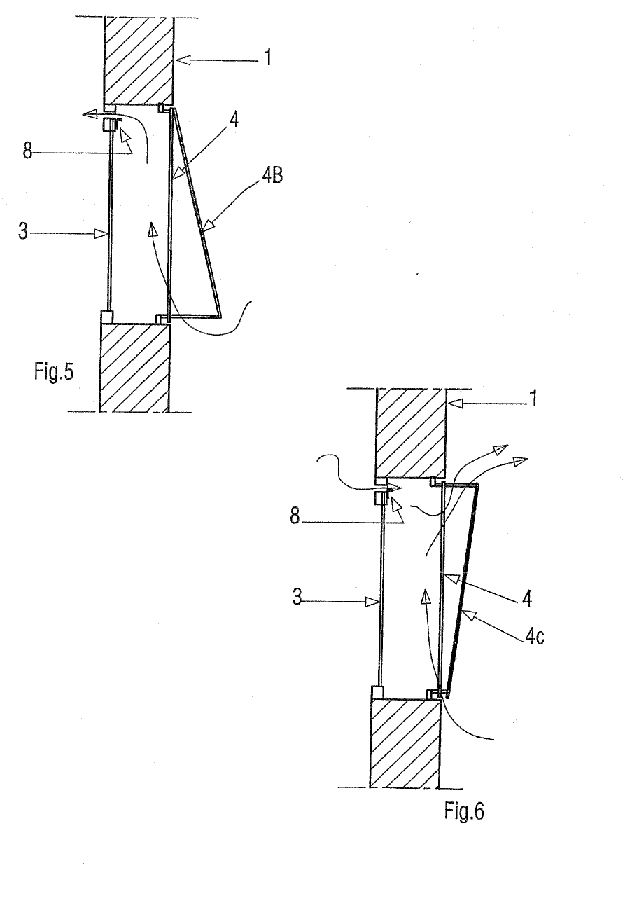

Other disadvantages and characteristics of the invention will become apparent from reading the following description of the preferred form of the invention, given by way of nonlimiting examples that are illustrated by the attached drawings in which:
FIG. 1 is a schematic cross-section of a window equipped with a shutter according to the invention.
FIGS. 2, 3, 4 are schematic cross-sections of variant embodiments.
FIG. 5 shows an embodiment in which the shutter can be moved away from the window by the bottom.
FIG. 6 shows one embodiment in which the shutter can be moved away from the window by the top and by the bottom.

FIG. 1 shows a construction wall 1 provided with a window opening according to a schematic cross-section.

The window, or French window on the storm window, or the picture window 3 is shown in three possible positions.

According to reference 3, the window is on the interior side of the wall 1.

According to reference 3A, the window is placed in the thickness of the wall.

According to reference 3B, the window is placed on the outer side of the wall without going past the facade.

A shutter 4 is placed in the opening 2 in the facade and in alignment with the surface of the latter.

According to the invention, the shutter 4 is composed of a wall that is made of rigid and transparent material. The shutter blocks the opening and protects the window 3 against inclement weather.

Being transparent, it allows passage of light and the view and thus does not conceal the window.

According to the invention, the shutter 4 can have one or more elements.

The shutter 4 can be placed in a fixed position by any known means, and since it allows light to pass and does not block the view, it is not necessary to open and close it all the time.

Advantageously, the fixing means of the shutter of any known type allow its removal if necessary.

The wall of the shutter according to the invention can be articulated to the wall by a system of traditional hinges allowing it to be opened.

It can likewise be composed of two leaves edge to edge in the middle of the opening, and or can cover one another in the middle of the opening, each of the leaves being articulated onto the opening.

Between the window 3 and the shutter 4, there is a buffer space 5, which optimizes the solar gain while making the shutter act as a passive solar collector.

The wall comprising the shutter 4 can be made of any transparent material:
becoming opaque and thus reflecting at least partially the light and solar radiation.
and/or having the property of reflection of the heat from the interior and/or exterior.

Such materials that change appearance under the effect of solar radiation or by changing the polarity and electrical intensity are known. The role of passive solar sensor of the shutter has been demonstrated by tests that have been run and that have shown that for an outside temperature varying over several days from −5° to +16.5°, a temperature between the window 3 and the shutter 4 of +8° to +26.5° was obtained.

FIG. 2 shows one variant embodiment in which the shutter 4, placed on the facade, can be arranged by suitable means in position 4A, shown in dotted lines where it has been moved away from the facade to allow passage of air.

This mounting is a good idea when the opening 2, window or French window, has a ventilation function.

In this case, the position of the shutter is regulated by spacing from the opening. This spacing can be controlled and slaved to an internal air quality system for the room that has the opening 2.

If the opening does not have a ventilation function, the transparent shutter 4 is attached to the opening as tightly as possible.

For this purpose, the shutter can be provided with a frame that is not shown, preferably as narrow as possible if it is opaque, or a peripheral joint for connection to the opening or a frame that is placed in the opening.

Preferably, the joint is made of a transparent or translucent material.

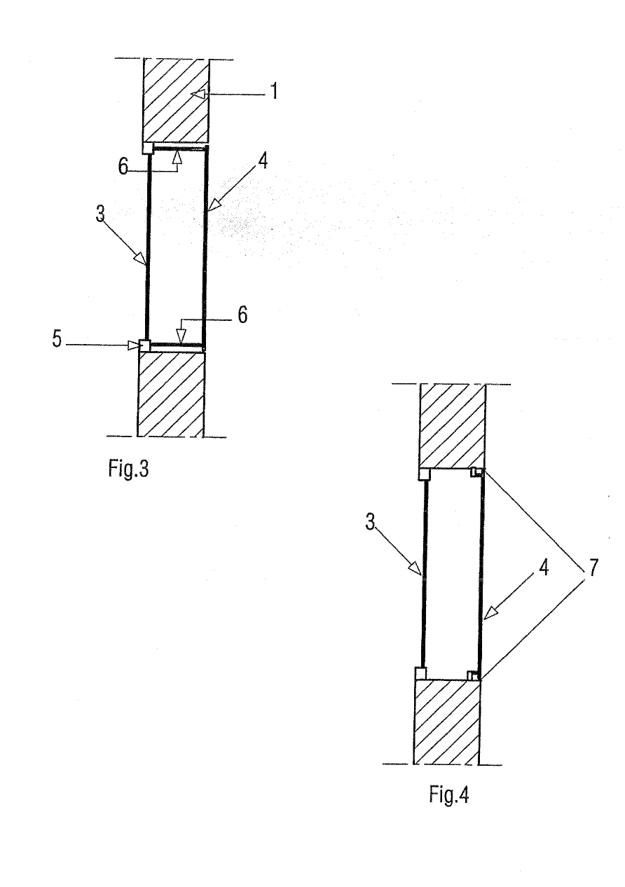

FIG. 3 shows another embodiment in which the shutter 4 is fixed to the uprights 5 of the inside window by crosspieces 6. Advantageously, these crosspieces 6 can be sliding rods allowing the shutter to move away from the front of the wall 1, for example to allow ventilation.

FIG. 4 shows an embodiment in which the shutter 4 is placed in a fixed position and is surrounded by a peripheral joint 7. The shutter according to the invention is designed to be placed in a fixed position in front of the opening 2. Between seasons, it can be removed.

The wall 4 of the shutter that is made of one or more elements can be made of any suitable, rigid, and transparent materials such as glass, plexiglass (registered trademark), polycarbonate, etc.

FIG. 5 shows an embodiment in which the shutter can be moved away from the opening of the window by the bottom by any suitable control means, manual or mechanical or motorized.

In this embodiment, the window is provided with an air aperture, in the upper part, with an automated closing element 8, of which the opening that can be adjusted is made sufficiently parallel from the spacing of the shutter.

This movement of the shutter is sufficient to allow a draft of natural air from the exterior toward the interior to regulate the temperature of the room, for example to heat it.

FIG. 6 shows an embodiment in which the shutter moves away from the top relative to the opening of the window and likewise by a very small amount from the bottom.

This arrangement combined with the air aperture with the closing element 8 creates a draft of air from the interior to the exterior, as shown by the arrows, to regulate the temperature of the room, for example to cool it down.

The closing element can be a simple closing element or a baffle closing element to obtain sound insulation.

The opening of the air aperture and the regulation of the closing element are done in parallel, i.e., in conjunction with the movement of the shutter.

The movements of the shutter and the opening and closing of the closing elements can be obtained by any suitable motor means or by systems with shape memory materials.

The opening of the air aperture can be regulated.

Movement and regulation can be controlled by photovoltaic cells on the periphery of the shutter.

The air aperture can be produced on the window or on the sill of the latter.

This air aperture can be assisted by a fan.

This fan can be a silent fan with photovoltaic supply or can be connected to the network.

The advantage of the fan is to obtain better regulation of the air flow rates relative to CO2 levels and to the temperature of the room.

This transparent shutter can accommodate photovoltaic cells for its own energy means.

1. New type of shutter for the opening (2) of a building intended to protect it against inclement weather, said shutter being located on the facade in front of the window or the French window or picture window, characterized in that it is composed of a wall (4) that is made of one or more elements made of a transparent material.

2. New type of shutter according to claim 1, wherein it can move away from the opening of the window by the bottom.

3. New type of shutter according to claim 1, wherein it can move away from the opening of the window by the top and by the bottom.

4. New type of shutter according to claim 2, wherein it is attached in an articulated manner to the frame of the opening.

5. New type of shutter according to claim 2, wherein the wall (4) comprising it is placed in a fixed position on the facade of the wall (1), without the need to open and close it on a daily basis.

6. New type of shutter according to claim 2, wherein the wall comprising the shutter can be spaced relative to the opening to allow passage of air.

7. New type of shutter according to claim 1, wherein it is attached to the frame of the opening by a joint.

8. New type of shutter according to claim 1, wherein it is made of a material that reflects light and/or heat.

9. New type of shutter according to claim 8, wherein the window is provided with an air aperture 8.
